(19) United States
(12) Patent Application Publication
(10) Pub. No.: US 2010/0052607 A1
(43) Pub. Date: Mar. 4, 2010

(54) Solar Charging Device and Method Thereof

(75) Inventor: Chien-An Chen, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: Pegatron Corporation, Taipei (TW)

(21) Appl. No.: 12/547,025

(22) Filed: Aug. 25, 2009

(30) Foreign Application Priority Data
Aug. 27, 2008 (TW) 97132810

(51) Int. Cl. H01M 10/46

(52) U.S. Cl. 320/101

(57) ABSTRACT

A solar charging device and method for charging a power storage module are provided. The solar charging device includes a solar charging module, a control module, and a first connection interface. The solar charging module converts light to electricity to generate charging power. The control module is coupled to the solar charging module. One terminal of the first connection interface is coupled to the control module, and the other terminal is removably coupled to the power storage module for transmitting the charging power passing through the control module to the power storage module.

### CROSS-REFERENCE TO RELATED APPLICATIONS

This non-provisional application claims priority under 35 U.S.C. §119(a) on Patent Application No. 97132810 filed in Taiwan, R.O.C. on 27 Aug. 2008 the entire contents of which are hereby incorporated by reference.

### BACKGROUND OF THE INVENTION

1. Field of the Invention

The invention relates to a charging device and method thereof and, more particularly, to a solar charging device and method thereof.

2. Description of the Related Art

With improvement of environment consciousness and decreasing of petroleum, a green energy industry has been paid much attention. A solar device is a popular product in the green energy industry. The solar device employs a solar charging module to absorb solar light and converts the light to electricity to provide a power source for different kinds of electronic products. Compared with the general power generation device, the energy needed by the solar device is solar light in the nature, and less harmful substances may be generated during the electricity converting process. Thus, the solar device is taken more seriously.

In the prior art, a solar device mainly includes a solar charging module, a control circuit, and a secondary cell. The solar charging module converts light into electricity, and the control circuit controls the electricity to charge the secondary cell. If the solar device is used to charge an external electronic product, the secondary cell of the solar device needs to be discharged to the external electronic product, thus to complete charging the external electronic product. According to the above, for the conventional solar device, the solar charging module needs to convert the light to the electricity for charging the secondary cell of the solar device first, and then the secondary cell of the solar device provides the electricity to charge a secondary cell of the electronic product. Thus, the power conversion efficiency decreases, and the charging time increases.

In addition, in the prior art, the solar device is assembled by integrating the solar charging module, the control circuit, and the secondary. However, a number of charge/discharge cycles and a lifespan of the secondary cell are limited. Therefore, if the secondary cell of the solar device fails, the whole solar device also fails and cannot be used.

### BRIEF SUMMARY OF THE INVENTION

This invention provides a solar charging device and method thereof. According to the device and method thereof provided by the invention, electricity converted by a solar charging module can be directly provided for charging an electronic product. In addition, according to the device and method thereof provided by the invention, the problem in the prior art that the solar device fails with the failure of a secondary cell of the solar device can be solved, thereby prolonging a lifespan of the solar device.

The embodiment of the invention provides a solar charging device for charging a power storage module. The power storage module is directly installed at an electronic product to provide power. The solar charging device includes a solar charging module, a control module, and a first connection interface. The solar charging module converts light to electricity to generate charging power. The control module is coupled to the solar charging module. One terminal of the first connection interface is coupled to the control module, and the other terminal is removably coupled to the power storage module for transmitting the charging power passing through the control module to the power storage module.

The embodiment of the invention also provides a method for charging a power storage module by solar energy. The method includes the following steps. A solar charging module is provided for converting light from a light source to generate charging power. A first connection interface is provided. In a charged state, the first connection interface is coupled to the power storage module for transmitting the charging power to the power storage module. In a discharged state, the first connection interface is removed from the power storage module to allow the power storage module to discharge.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing a solar charging device according to a first embodiment of the invention;

FIG. 2 is a schematic diagram showing a solar charging device according to a second embodiment of the invention;

FIG. 3 is a schematic diagram showing a solar charging device according to a third embodiment of the invention;

FIG. 4 is a schematic diagram showing a solar charging device according to a fourth embodiment of the invention; and

FIG. 5 is a flowchart showing a method for charging by solar energy.

### DETAILED DESCRIPTION OF THE INVENTION

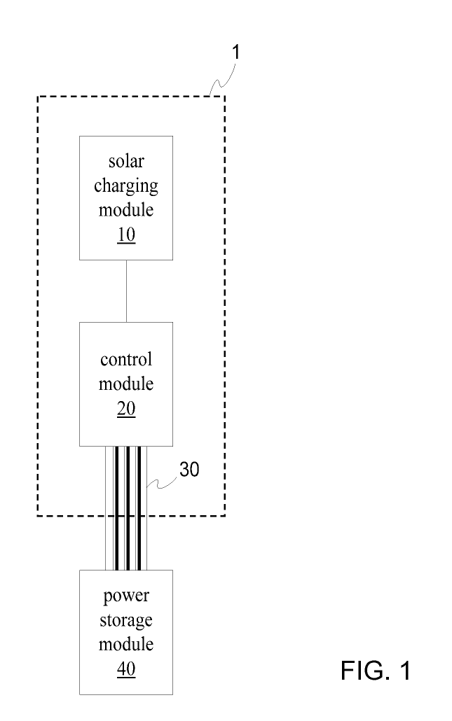

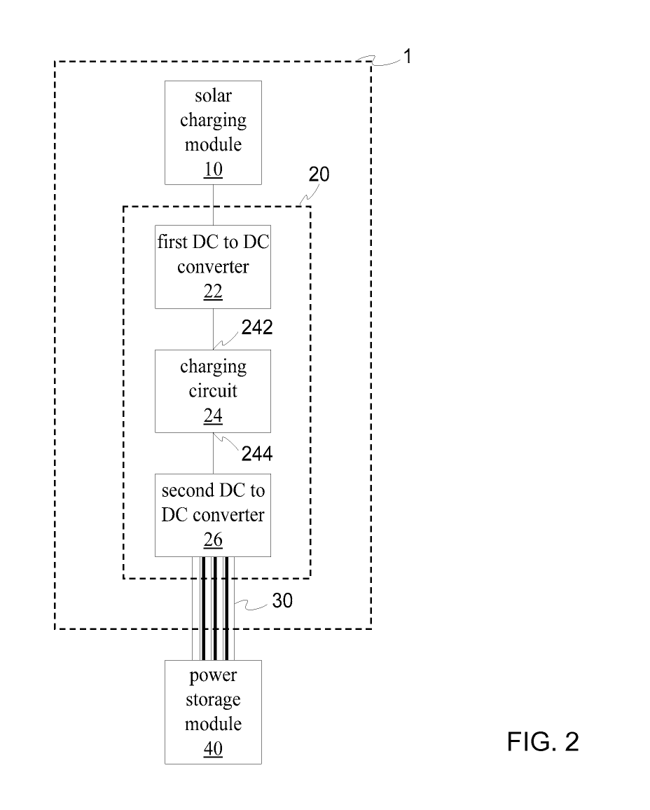

FIG. 1 and FIG. 2 are schematic diagrams showing a solar charging device according to a first embodiment and a second embodiment of the invention, respectively. Please refer to FIG. 1 and FIG. 2. A solar charging device 1 is provided for charging a power storage module 40. The power storage module 40 may be directly installed at an electronic product for providing power. The solar charging device 1 includes a solar charging module 10, a control module 20, and a first connection interface 30.

The solar charging module 10 converts light from a light source to generate charging power, and the control module 20 is coupled to the solar charging module 10. The control module 20 includes a first DC to DC converter 22, a charging circuit 24, and a second DC to DC converter 26.

The first DC to DC converter 22 regulates the charging power after it receives the charging power generated by the solar charging module 10. The charging circuit 24 has a first terminal 242 and a second terminal 244. The first terminal 242 is coupled to the first DC to DC converter 22. The second DC to DC converter 26 is coupled to the second terminal 244 of the charging circuit 24 for boosting the charging power passing through the first DC to DC converter 22 and the charging circuit 24.

For example, generally, the charging power generated by the solar charging module 10 is mostly 3.3 volts after passing through the first DC to DC converter 22 and the charging circuit 24. However, a charging power voltage needed by an external electronic product is 5 or 9 volts, which may change with the power source of the electronic product. Therefore, the second DC to DC converter 26 needs to boost the original charging power of 3.3 volts to be 5 or 9 volts, to facilitate the subsequence charging.

One terminal of the first connection interface 30 is coupled to the control module 20. In a charged state, the other terminal is coupled to the power storage module 40 for transmitting the charging power passing through the control module 20 to the power storage module 40. However, in a discharged state, the terminal of the first connection interface 30 originally coupled to the power storage module 40 is removed from the power storage module 40, such that the first connection interface 30 is not coupled to the power storage module 40. Thus, the power storage module 40 can be removed from the first connection interface 30 for discharge. The power storage module 40 may be a secondary cell of any electronic product, and the secondary cell is a battery which can be charged and discharged.

According to the above, in the charged state, the charging power generated by the solar charging device 1 directly charges the power storage module 40 via the first connection interface 30. Further, the power storage module 40 is a secondary cell of an electronic product. Therefore, after the power storage module 40 receives the charging power transmitted by the solar charging device 1 and is charged, it enters into the discharged state. At that moment, the power storage module 40 may be removed from the first connection interface 30 to directly provide power for the corresponding electronic product. Therefore, the first connection interface 30 is similar to a universal terminal capable of connecting a secondary cell of different kinds of electronic products.

A mobile phone as the electronic product and a lithium cell of the mobile phone as the power storage module 40 are taken for example. When the lithium cell of the mobile phone exhausts, the solar charging device 1 is used to charge the lithium cell. At that moment, the lithium cell just needs to be coupled to the first connection interface 30. Thus, the charging power generated by the solar charging device 1 may be directly transmitted to the lithium cell via the first connection interface 30, thereby charge the lithium cell. After the lithium cell is charged, the lithium cell may be removed from the first connection interface 30, and it may be assembled into the mobile phone again.

According to the above, the solar charging device 1 directly provides the generated charging power for charging the secondary cell of the electronic product, which is different from the prior art. In the prior art, the charging power is first provided for charging the secondary cell of the solar charging device, and then the secondary cell of the solar charging device is discharged to the secondary cell of the electronic product. Therefore, according to the solar charging device 1 provided in the embodiments of the invention, the charging time is saved, and the charging efficiency is improved. In addition, since the solar charging device 1 is not integrated with the secondary cell, the whole solar charging device 1 can still be used even when the secondary cell is damaged.

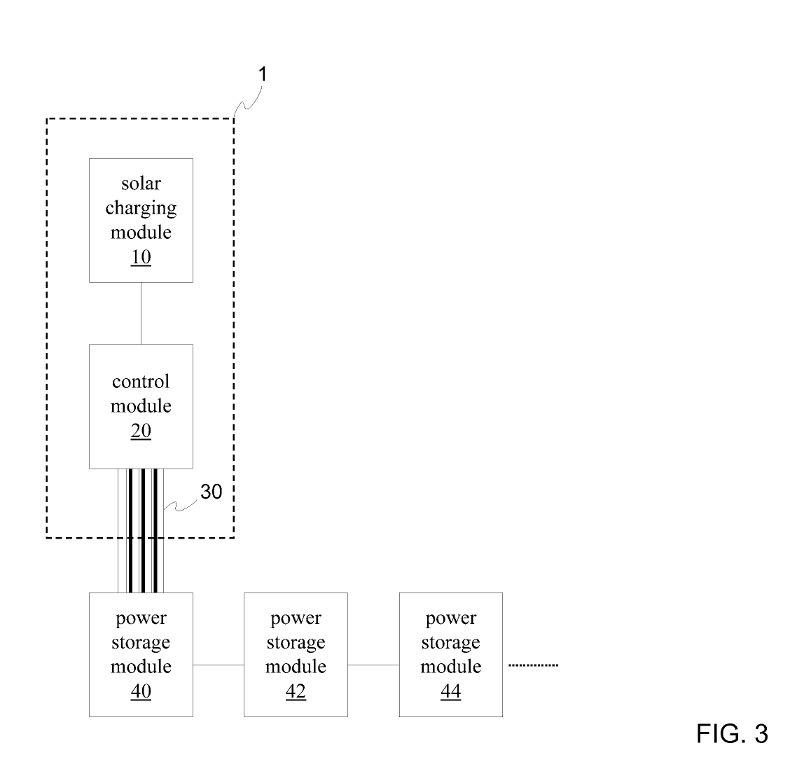

FIG. 3 is a schematic diagram showing a solar charging device according to a third embodiment of the invention. Please refer to FIG. 3. In the third embodiment, a first connection interface 30 may be coupled to a plurality of power storage modules 40, 42, 44 and so on. When the first connection interface 30 is coupled to the power storage modules 40, 42, 44, according to a charging sequence signal generated by the control module 20, it sequentially transmits charging power to each of the power storage modules 40, 42, 44.

For example, when a user is to have a oversea travel for a time, he or she can couple secondary cells of a plurality of electronic products such as a notebook computer, a mobile phone, a MP3 player and so on to the first connection interface 30 before the travel, thereby use the solar charging device 1 to charge the secondary cells of the electronic products during the travel. At that moment, the control module 20 may generate a charging sequence signal. Thus, each of the coupled secondary cells is charged sequentially. The charging sequence signal may be set by users or may be a predetermined value of the solar charging device 1.

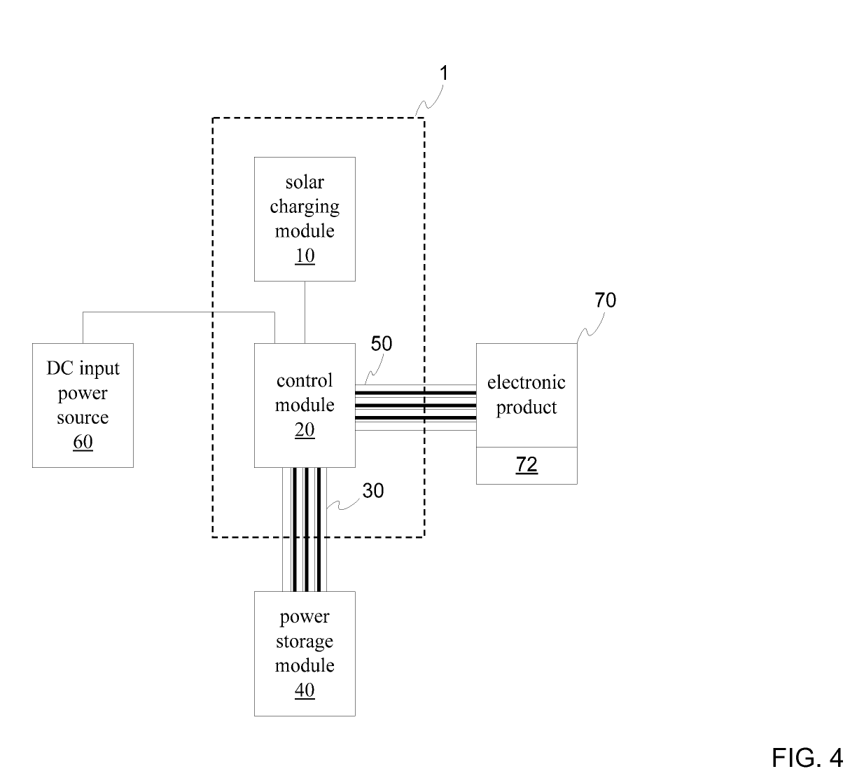

FIG. 4 is a schematic diagram showing a solar charging device according to a fourth embodiment of the invention. Please refer to FIG. 4. In the fourth embodiment, the solar charging device further includes a second connection interface 50.

One terminal of the second connection interface 50 is coupled to a control module 20, and the other terminal is coupled to an electronic product 70 for transmitting charging power passing through the control module 20 to the electronic product 70. That is, besides a first connection interface 30 coupled to the power storage module 40 for charge, the solar charging device 1 further has the second connection interface 50 coupled to the external electronic product 70 for directly transmitting the charging power generated by the solar charging device 1 to the electronic product 70, thereby charging a secondary cell 72 of the electronic product 70.

In addition, to prevent the solar charging module 10 from failing to generate the charging power due to inadequate light, the control module 20 can be coupled to a DC input power source 60 for providing the charging power when the light is inadequate.

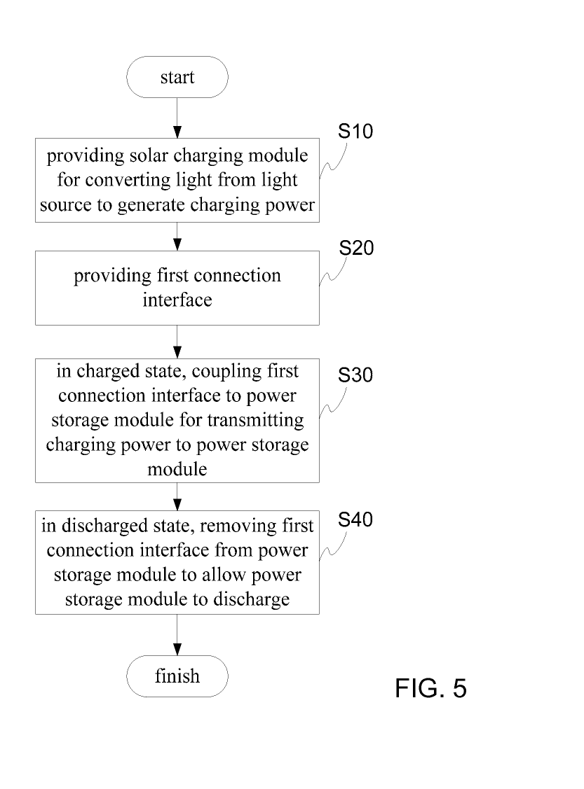

FIG. 5 is a flowchart showing a method for charging a power storage module by solar energy. The method includes the following steps.

In step S10, a solar charging module is provided for converting light from a light source to generate charging power. This step includes the following steps. The charging power is received and regulated. Then the charging power is boosted.

In step S20, a first connection interface is provided.

In step S30, in a charged state, the first connection interface is coupled to a power storage module for transmitting the charging power to the power storage module. The power storage module is a secondary cell of an electronic product.

In step S40, in a discharged state, the first connection interface is removed from the power storage module to allow the power storage module to discharge.

The first connection interface can be coupled to a plurality of power storage modules. Therefore, the following steps are included. The first connection interface is coupled to a plurality of power storage modules. According to a charging sequence signal, the charging power is sequentially transmitted to each of the power storage modules.

In addition, to prevent the inadequate light from affecting the solar charging device, a DC input power source is coupled for providing the charging power when the light is inadequate.

In addition, besides charging the power storage module, the solar charging device also provides the charging power for an external electronic product. Therefore, the following steps are included. A second connection interface is coupled to the electronic product and transmits the charging power to the electronic product.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A solar charging device for charging a power storage module, the solar charging device comprising:
a solar charging module for converting light to electricity to generate charging power;
a control module coupled to the solar charging module; and
a first connection interface, one terminal of the first connection interface coupled to the control module, the other terminal of the first connection interface removably coupled to the power storage module for transmitting the charging power passing through the control module to the power storage module.

2. The solar charging device according to claim 1, wherein the control module comprises:
a first DC to DC converter receiving the charging power and regulating the charging power;
a charging circuit having a first terminal and a second terminal, the first terminal coupled to the first DC to DC converter; and
a second DC to DC converter coupled to the second terminal of the charging circuit for boosting the charging power passing through the first DC to DC converter and the charging circuit.

3. The solar charging device according to claim 1, wherein the power storage module is a secondary cell of an electronic product.

4. The solar charging device according to claim 1, wherein the first connection interface is coupled to a plurality of power storage modules, and according to a charging sequence signal generated by the control module, the first connection interface sequentially transmits the charging power to each of the power storage modules.

5. The solar charging device according to claim 1, wherein the control module is coupled to a DC input power source for providing the charging power when the light is inadequate.

6. The solar charging device according to claim 1, further comprising:
a second connection interface, one terminal coupled to the control module, the other terminal coupled to an electronic product for transmitting the charging power passing through the control module to the electronic product.

7. A method for charging a power storage module by solar energy, the method comprising the following steps of: providing a solar charging module for converting light from a light source to generate charging power;
providing a first connection interface;
coupling the first connection interface to the power storage module for transmitting the charging power to the power storage module in a charged state; and
removing the first connection interface from the power storage module to allow the power storage module to discharge in a discharged state.

8. The method according to claim 7, wherein after the step of generating the charging power, the method comprises the following steps of:
receiving the charging power;
regulating the charging power; and
boosting the charging power.

9. The method according to claim 7, wherein the power storage module is a secondary cell of an electronic product.

10. The method according to claim 7, further comprising the following steps of:
coupling the first connection interface to a plurality of power storage modules; and
transmitting the charging power to each of the power storage modules sequentially according to a charging sequence signal.

11. The method according to claim 7, further comprising the following step of:
coupling a DC input power source for providing the charging power when the light is inadequate.

12. The method according to claim 7, further comprising the following steps of:
providing a second connection interface coupled to an electronic product; and
transmitting the charging power to the electronic product.
